(19) United States
(12) Patent Application Publication
(10) Pub. No.: US 2011/0029200 A1
(43) Pub. Date: Feb. 3, 2011

(54) PULL DRIFT COMPENSATION USING ACTIVE FRONT STEERING SYSTEM

(76) Inventor: Jitendra Shah, Kolkata (IN)

Correspondence Address: ANGELA M. BRUNETTI, PLLC, 3233 Lake Forest Dr., Sterling Heights, MI, 48314, US

(21) Appl. No.: 12/848,242

(22) Filed: Aug. 2, 2010

(30) Foreign Application Priority Data
Aug. 3, 2009 (DE) 102009028181.9

(51) Int. Cl. B62D 6/04

(52) U.S. Cl. 701/41

(57) ABSTRACT

A method for correcting straight-ahead driving of a motor vehicle having an active front steering system comprising the steps of determining a straight-ahead driving condition of the motor vehicle, detecting pull or drift of the motor vehicle during the straight-ahead driving condition and adjusting the steering column using the active front steering system to compensate for detected pull or drift of the motor vehicle.

### CROSS REFERENCE

The inventive subject matter is a continuation of German Patent Application No. DE 102009028181.9, filed Aug. 3, 2009 entitled “Pull-Drift Compensation by Means of AFS” the entire disclosures of which are hereby incorporated by reference into the present disclosure and provides the basis for a claim of priority of invention under 35 U.S.C. §119.

### TECHNICAL FIELD

The inventive subject matter relates to pull-drift compensation and more particularly to pull-drift compensation using an active front steering system.

### BACKGROUND

Power-assisted steering devices for motor vehicles are implemented with hydraulic assistance (HPAS), with electro-hydraulic assistance (EHPAS) or with electro-mechanical assistance (EPAS). For specific driving situations, such as parking, it is possible to provide a variably adjustable transmission ration between a steering movement which is applied to the steering device by the user, as by a steering wheel, and by the adjustment movement of an adjustment device which serves to steer at least one steerable wheel of the motor vehicle.

In order to implement a transmission ration which can be adjusted variably and, if appropriate, as a function of the speed, it is known to disconnect the mechanical connection between the steering wheel and the adjustment device, which is usually referred to as the steering column, and to provide a steering angle adjustment device at the disconnection point. The steering angle adjustment device permits a differential adjustment angle to be set between the steering wheel and adjustment device in order, for example when maneuvering the motor vehicle, to be able to provide a different steering transmission ratio than at higher speeds in the driving mode (superposed gearing). Steering devices with a disconnected steering column may be referred to as active front steering systems (AFS).

The active front steering system may be implemented as a combination of a planetary gearing connected to the opposite end regions of the disconnected steering column, and of an electric motor acting on the planetary gearing. The electric motor is activated by a control unit which obtains and processes information from the steering device, from the adjustment device and from a device for determining the vehicle speed.

The active steering system may make available an increased sensation of comfort to the driver and at the same time may stabilize the motor vehicle. The required angle for the gearing is determined, for example, by means of an algorithm. The motor-gearing unit is blocked, i.e., taken out of operation, when running up or staring the system and if a system error is identified.

An active front steering system is generally supplemented by the power assisted steering system (PAS) in order to reduce the steering adjustment forces required.

During straight-ahead driving of the vehicle, the motor vehicle may stop driving straight ahead, i.e., may drift or pull, due to torques which occur. The driver attempts to counteract this with a corresponding counter-steering torque.

Such torques are generally unavoidable effects inherent to the vehicle caused by a faulty vehicle setting or a vehicle setting that has become faulty, for example, different tire pressure, tire shape, adjustment of the steering geometry, or differences in the suspension system. Since the effects are of a comparably long duration, a long term correction may be in order. Second, conditions that are a function of a driving situation, such as side wind, road curvature, etc., may also have an effect on the driving dynamics such that drift occurs necessitating the driver apply additional torque to the steering wheel to compensate for the drift or to correct the undesirable steering behavior. Since these disturbances are of a comparably short duration, a short term correction may be in order.

The corrections are carried out by the power-assisted steering system, as disclosed, for example in DE 10 2006 022 663 B4, which discloses a method for improving straight-ahead driving of a vehicle with a steering system having power assisted steering, i.e., with an electro-mechanical or hydraulic assisted steering system (EPAS, HPAS), which records data related to driving dynamics, identifies a state of the straight-ahead movement from the recorded data when circumstances indicate that at least one value of the recorded data, or a value derived from the data, drops below or exceeds a predetermined threshold value for a predetermined period of time or a predetermined distance. The torque applied to the steering wheel is measured at least during straight-ahead movement, and a required compensation torque is calculated from the measured torque. The power assisted steering system is activated with the calculated compensation torque to counter-compensate for the measured torque applied to the steering system. Frictional forces are taken into consideration by a frictional value being subtracted from the measured torque and resetting torque value being added to the measured torque value during straight-ahead movement.

Although a correction of this type has proven advantageous, it cannot be ruled out that the driver will still perceive the correction by means of the power assisted steering system, i.e., by means of the servo steering system, due to a slight, but nonetheless undesirable rotation of the steering wheel or due to an additional, perceptible counter-steering movement of the steering wheel.

There is a need for providing an improved method for correcting pull-drift that occurs during straight-ahead movement of a motor vehicle so that the driver does not perceive the correction being made by the system.

### SUMMARY

The inventive subject matter is a method for correcting straight-ahead movement of a motor vehicle. After detecting straight-ahead driving of the motor vehicle, pull or drift is identified. A superposed value for torque assistance is calculated and made available by an adjustment unit of an active front steering system such that the power-assisted power steering device provides the required assistance. The pull-drift compensation is advantageously not carried out solely with the aid of the power-assisted servo steering system, but with the additional assistance of the active front steering system. In this respect, the inventive subject matter introduces a combined system in which a correction torque, or a correction angle, is applied to the steering column by means of the AFS in order to obtain the required assistance from the power-assisted steering system. The driver therefore no longer perceives the pull-drift compensation and the offset applied to the steering wheel.

An advantage of the inventive subject matter is that the method is carried out by making adjustments to the steering column by way of the AFS. The method first detects straight-ahead driving of the motor vehicle. A current steering wheel torque applied by the driver is compared to a minimum limit value of a steering wheel torque during straight-ahead driving to determine if the current steering wheel torque applied by the driver is greater than at least the minimum limit value. Irrespective of the result of the comparison, a determination is made as to whether the vehicle is no longer driving straight-ahead if a current steering wheel torque applied by the driver has a value of zero. The states identified in the first three steps are passed on as input signals to a control unit. In the control unit, a superposition angle is determined and a superposition signal is generated therefrom. The superposition signal is supplied to the adjustment unit of the active front steering system such that the superposition signal is applied to the steering column in a manner that the power-assisted steering device provides the required assistance to maintain straight-ahead driving in a manner that is imperceptible at the steering wheel and therefore remains imperceptible to the driver of the vehicle.

### DESCRIPTION OF DRAWINGS

FIG. 1 is a schematic illustration of a steering system incorporating the method of the present invention;

FIG. 2 is a block diagram of the method of the present invention; and

FIG. 3 is a block diagram of the method of the present invention.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DESCRIPTION OF INVENTION

While various aspects of the present invention are described with reference to a particular illustrative embodiment, the invention is not limited to such embodiments, and additional modifications, applications, and embodiments may be implemented without departing from the present invention. In the figures, like reference numbers will be used to illustrate the same components. Those skilled in the art will recognize that the various components set forth herein may be altered without varying from the scope of the inventive subject matter.

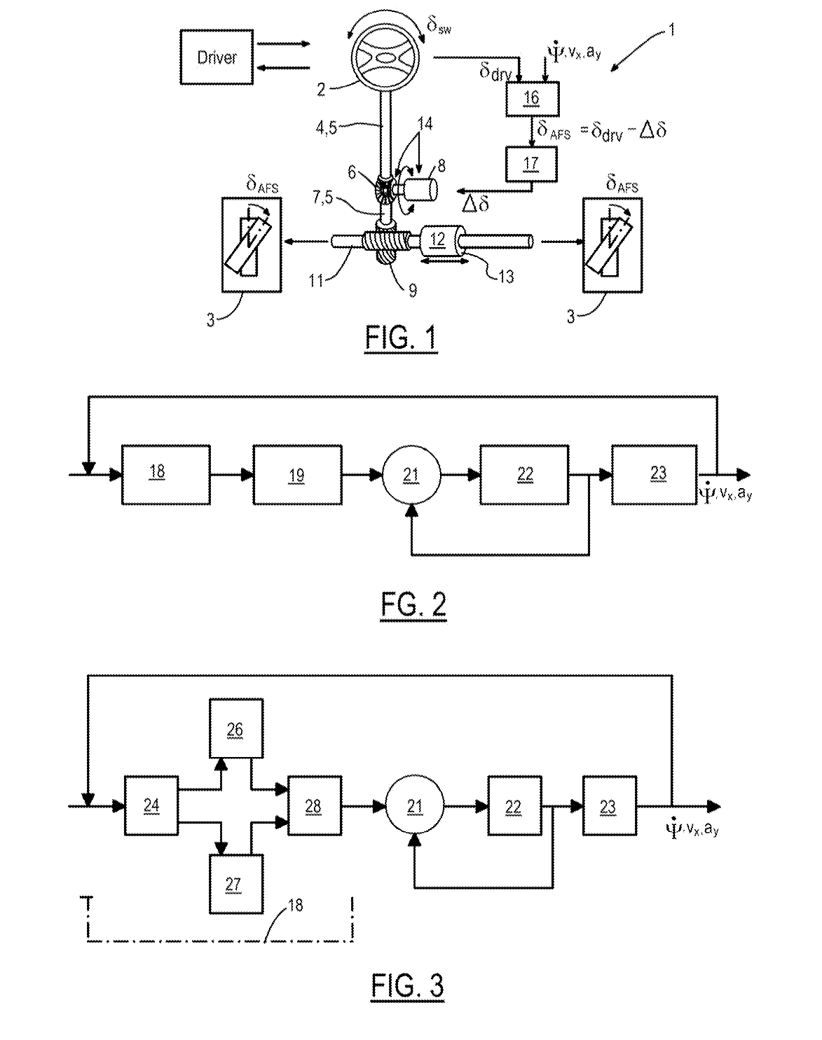

FIG. 1 is a schematic illustration of a steering system having an active front steering system. The steering system 1 transmits steering movements of a steering wheel 2 to vehicle wheels 3. The steering wheel 2 is connected in a rotationally fixed manner to an upper steering column section 4 which is a shaft that permits steering torques to be transmitted.

The upper steering column section 4 is coupled to a lower steering column section 7 by way of a superposition gearing 6. The two steering column sections 4 and 7 together form a steering column 5. A drive wheel of the superposition gearing 6 is mounted on a shaft of an adjustment unit 8. In a preferred embodiment, adjustment unit 8 is an electric motor, such that by actuation of the motor, a rotational angle differential may be applied between the upper steering column section 4 and a the lower steering column section 7. An end side of the lower steering column section 7 has a steering pinion 9 which engages a toothed rack 11 in such manner that rotation of the steering pinion 9 leads to a translation of the toothed rack 11. The toothed rack 11 is coupled in each case at the end sides to the wheels 3 by way of track rods (not shown) and permits the wheels 3 to rotate about a substantially vertical oriented axis to bring about steering movement.

The toothed rack 11 is equipped with a coaxially arranged assistance motor 12 which engages in a spindle section (not shown) of the toothed rack 11 and permits axial forces to be applied in direction of main extent of the toothed rack 11.

Pull-drift compensation (PDC) is a method for reducing a constant pull on the steering wheel during straight-ahead driving of the motor vehicle. Determination of a straight-ahead driving condition is an important consideration for pull-drift compensation. If a driver has at least one hand on the steering wheel, or applies a steering torque to the steering wheel in a different form despite straight-ahead driving, a comparison to a minimum limit value should be made. The results of a comparison are important to determine if the steering torque is identified as a counter-steering torque. However, if the driver does not have a hand on the steering wheel no steering torque is being applied to the steering wheel, in which case, the vehicle may drift out of line despite straight-ahead driving having been identified. PDC angle offset is defined by a required gearing angle and a measured gearing angle as:

PDC angle offset=required gearing angle±measured gearing angle (2)

If pull-drift compensation is not required, as when no straight-ahead driving of the motor vehicle is detected for a predetermined amount of time or distance, the PDC angle offset is zero.

In principle, for the compensation of pull-drift, it is required that straight-ahead driving of the motor vehicle is detected. If this requirement is met and if signals, such as lateral accelerations and yaw angles, are significantly increased with respect to respective desired values in order to keep the motor vehicle on the straight line path, when the steering wheel torque applied by the driver is zero or greater than a minimum limit value, it is recognized that pull-drift compensation should be carried out by the AFS according to the inventive subject matter. It is therefore provided that detection of lateral acceleration and yaw rate signals with reference to the steering wheel angle are suitably made.

Referring again to FIG. 1, a driver applies a steering wheel angle, shown by the arrow pointing towards the steering wheel, to the steering wheel 2 in response to a reactionary torque, shown by the arrow pointing towards the driver, from the steering wheel 2. The steering moment applied to the steering wheel 2 by the driver may be detected with the aid of a steering angle sensor and transmitted to a control unit. In the control unit, the steering angle is derived over time, thus resulting in a steering angle speed at a particular instant.

The steering system 1 has both a power-assisted steering device 13 and an active front steering system 14. The power-assisted steering device 13 has the assistance motor 12, which may be an EPAS, and HPAS or an EHPAS. The active front steering device 14 has the adjustment unit 8. The active front steering device 14 may also be referred to the active front steering system, AFS and includes the superposition gearing 6 which is operatively connected to the steering wheel 2. The steering wheel 2 is operated by the driver. A superposition angle or motor angle generated by the superposition gearing 6 is set by way of the electric motor 8 in order to set a wheel steer angle to a wheel steer angle generated by the AFS system, δ_{AFS}. Driver steering angle, δ_{drv} and a predetermined motor angle Δδ define:

δ_{AFS}=δ_{drv}−Δδ (2)

The superposition gearing 6 adds or subtracts the predetermined motor angle Δδ to or from the driver steering angle δ_{drv}. The sum of the two angles then accts on the steering gearing which generates the steer angle.

The driver steering angle δ_{drv} is predefined by the driver, resulting from the steering wheel angle δ_{sw}, and Δδ is the motor angle, or superposition angle, which is generated by the electric motor 8 by way of the AFS gearing 6 and is superposed on the driver steering angle δ_{drv}.

In order to obtain the superposition angle, input signals for yaw rate, Ψ, vehicle speed, σₓ, and lateral acceleration, a_{y}, are supplied, along with the driver steering angle, δ_{drv}, to the pull-drift compensation unit 16. The pull-drift compensation unit 16 uses the inputs to determine whether the motor vehicle is driving straight ahead. The pull-drift compensation unit 16 generates the angle δ_{AFS}. The signal Δδ is generated in a control unit 17 such that pull or drift is superposed in accordance with the superposed value generated in the electric motor 8 by means of the signal supplied thereto.

FIG. 2 is a block diagram representing the method for correcting straight-ahead driving of the motor vehicle according to the present invention. Block 18 is representative of the AFS 14 and the PDC unit 16 as described with reference to FIG. 1. Referring to FIG. 2, the AFS and pull drift compensation unit are used to first detect straight-ahead driving 18 of the motor vehicle and identify a current steering wheel torque. Block 19 represents a pinion torque sensor. The steering wheel torque may be sensed by a pinion torque sensor. Block 21 is a linkage in the steering system. A power-assisted steering device 22 is represented by block 22 and block 23 represents the vehicle. The vehicle 23, typically through sensors, supplies yaw rate, vehicle speed, and lateral acceleration information to block 18 to be used by the AFS 14 and the PDC unit 16, as discussed above, to determine straight-ahead driving, detect pull and/or drift and determine the superposition signal Δδ.

FIG. 3 shows a more detailed embodiment of the invention in which input signals Ψ, βₓ and a_{y}, are used to determine whether the vehicle is in a straight-ahead driving condition. Block 18 is broken down into detail as blocks 24-28. In block 24, determination of a straight-ahead driving condition is made. Blocks 26 and 27 detect the presence of pull or drift. Block 28 generates the superposition angle.

If a pull on the steering wheel is detected 26, the driver is known to be applying a counter-steering torque to the steering wheel that is greater than a predetermined minimum limit steering torque during straight-ahead driving. When this state is identified, a corresponding superposition angle Δδ is generated 28. The superposition signal is determined such that the superposition value generated generates a corresponding provision of the auxiliary torque of the assistance motor 8 such that, despite the correction, the driver does not perceive the correction on the steering wheel 2, since a pull, which is constant for the driver, is generated on the steering wheel.

A drift out of straight-ahead driving when no steering wheel torque is applied may be detected 27. Drift may occur if the driver's hand is not on the steering wheel. When drifting is identified 27, a corresponding superposition signal Δδ is generated 28. The superposition signal is determined in such a manner that the superposition value generated generates a corresponding provision of the auxiliary torque of the assistance motor such that, despite the correction, the driver does not perceive the correction on the steering wheel. The steering wheel angle is virtually constant for the driver and is also generated on the steering wheel.

The effect achieved by the present invention is that the driver does not perceive the pull or drift compensation or an offset of the steering wheel during the particular compensation. This is because the AFS 14 advantageously acts together with the power-assisted steering system 13.

The method for correcting straight-ahead driving of the motor vehicle first detects straight-ahead driving of the motor vehicle. A determination is made if the current steering wheel torque applied by the driver during straight-ahead driving is greater than at least a minimum value of the steering wheel torque during straight-ahead travel. A determination is also made as to whether the motor vehicle is still driving straight-ahead if a current steering wheel torque applied by the driver has a value of zero. The states of straight-ahead driving and current steering wheel torque are passed on, as an input signal in accordance with Equation (2) to the control unit 17. In the control unit 17, an angle offset is determined and the superposition signal Δδ is generated. The superposition signal Δδ is supplied to the adjustment unit 8 of the AFS 14, such that a superposition value is applied to the steering column in such a manner that the power-assisted power steering device of the assistance motor 12 provides the required assistance.

It is advantageous that the method first identifies whether there is pull or drift and then identifies the superposition value which is intended to be made available by the adjustment unit of the AFS. Known methods use the power-assisted steering system in order to compensate for pull or drift. However, this may lead to a perceptible steering wheel angle offset. By linking the AFS with the task of pull-drift compensation, a constantly invariable steering sensation is set with the aid of the AFS and not solely by means of the power-assisted steering device.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. The equations may be implemented with a filter to minimize effects of signal noises. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

The terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A method for correcting straight-ahead driving of a motor vehicle having an active front steering system, the method comprising the steps of:
providing a lateral acceleration signal indicative of the lateral acceleration of the vehicle;
providing a yaw rate signal indicative of the yaw rate of the vehicle;
providing a steering wheel angle signal indicative of a driver steering angle;
providing a steering wheel torque signal indicative of a steering wheel torque;
determining a straight-ahead driving condition based on the yaw rate and the lateral acceleration with respect to the steering wheel angle;
wherein during the straight-ahead driving condition;
determining whether the steering wheel torque is zero or is greater than a predetermined minimum threshold value;
generating a superposition signal in response to the steering wheel torque determination;
generating a wheel steer angle for the active front steering system as a function of the driver steering angle and the superposition signal;
providing the wheel steer angle to an adjustment unit on the active front steering system; and
adjusting the steering column according to the wheel steer angle by way of the adjustment unit on the active front steering system.

2. The method as claimed in claim 1 wherein the step of generating a wheel steer angle further comprises adding the superposition signal to the driver steering angle.

3. The method as claimed in claim 1 wherein the step of generating a wheel steer angle further comprises subtracting the superposition signal from the driver steering angle.

4. A method for correcting straight-ahead driving of a motor vehicle having an active front steering system, the method comprising the steps of:
determining a straight-ahead driving condition of the motor vehicle;
detecting pull or drift of the motor vehicle during the straight-ahead driving condition; and
adjusting the steering column using the active front steering system to compensate for detected pull or drift of the motor vehicle.

5. The method as claimed in claim 4 wherein the step of adjusting the steering column further comprises the steps of:
determining a superposition signal in an electric motor of the active front steering system;
supplying the superposition signal to the active front steering system;
generating a wheel steer angle; and
adjusting the steering column by using the active front steering system according to the wheel steer angle thereby compensating for pull or drift of the motor vehicle and maintaining the straight-ahead driving condition.

6. The method as claimed in claim 5 wherein the step of generating a wheel steer angle further comprises adding the superposition signal to a driver steering angle.

7. The method as claimed in claim 5 wherein the step of generating a wheel steer angle further comprises subtracting the superposition signal from the driver steering angle.

8. The method as claimed in claim 5 wherein the step of detecting pull or drift further comprises determining a current steering wheel torque is greater than a minimum threshold value of steering wheel torque for straight-ahead driving.

9. The method as claimed in claim 5 wherein the step of detecting pull or drift further comprises determining the current steering wheel torque is zero.
